(19) United States
(12) Patent Application Publication
(10) Pub. No.: US 2019/0250342 A1
(43) Pub. Date: Aug. 15, 2019

(54) OPTICAL MODULE AND METHOD OF MANUFACTURING OPTICAL MODULE

(71) Applicant: Sumitomo Electric Industries, Ltd., Osaka (JP)

(72) Inventors: Yasushi FUJIMURA, Osaka (JP); Tomoya SAEKI, Osaka (JP)

(21) Appl. No.: 16/271,287

(22) Filed: Feb. 8, 2019

(30) Foreign Application Priority Data
Feb. 9, 2018 (JP) 2018-022136

(51) Int. Cl. G02B 6/42

(52) U.S. Cl. CPC G02B 6/4206; G02B 6/4262

(57) ABSTRACT

An optical module is disclosed. The optical module comprises an optical semiconductor element having a first optical axis thereof, an optical receptacle optically coupling with the semiconductor element and having a second optical axis thereof, a box-shaped housing having a bottom and a side wall built in an end of the bottom, and a beam shifter provided in the side wall. The housing encloses the optical semiconductor element therein but extracts the optical receptacle. The side wall of the housing demarcates the optical semiconductor element from the optical receptacle. The beam shifter aligns the first optical axis with the second optical axis.

### CROSS REFERENCE TO RELATED APPLICATIONS

This application is based upon and claims the benefit of priority from Japanese Patent Application No. 2018-022136, filed on Feb. 9, 2018, the entire contents of which are incorporated herein by reference.

### TECHNICAL FIELD

The present disclosure relates to an optical module and a method of manufacturing the optical module.

### BACKGROUND

JP2016-134535 A discloses an optical module used for coherent communication. The optical module comprises a light source, a modulator that receives outgoing light emitted from the light source, a housing for mounting the light source and the modulator on a bottom surface thereof, and a beam shifter provided on an optical path of the outgoing light. The beam shifter complements a horizontal level between an optical axis of the light source and an optical axis of the modulator.

### SUMMARY

The present disclosure provides an optical module. The optical module comprises an optical semiconductor element having a first optical axis thereof, an optical receptacle optically coupling with the semiconductor element and having a second optical axis thereof, a box-shaped housing having a bottom and a side wall built in an end of the bottom, and a beam shifter provided in the side wall. The housing encloses the optical semiconductor element therein but extracts the optical receptacle. The side wall of the housing demarcates the optical semiconductor element from the optical receptacle. The beam shifter aligns the first optical axis with the second optical axis.

### BRIEF DESCRIPTION OF THE DRAWINGS

The foregoing and other purposes, aspects and advantages will be better understood from the following detailed description of embodiments of the disclosure with reference to the drawings, in which:

FIG. 1 is a plan view illustrating an internal structure of an optical module according to an embodiment,

FIG. 2 is a cross-sectional view of the optical module taken along a line II-II indicated in FIG. 1,

FIG. 3 is a cross-sectional view schematically illustrating the optical module illustrated in FIG. 2,

FIG. 4 is data indicating a relationship between an angle and an offset amount of a beam shifter,

FIG. 5 is a flowchart showing a method of manufacturing the optical module,

FIG. 6 is a side cross-sectional view schematically illustrating a process of manufacturing the optical module,

FIG. 7 is a side cross-sectional view schematically illustrating a process of manufacturing the optical module,

FIG. 8 is a side cross-sectional view schematically illustrating a process of manufacturing the optical module,

FIG. 9 is a side cross-sectional view schematically illustrating a process of manufacturing the optical module,

FIG. 10 is a side cross-sectional view schematically illustrating an optical module according to a first modification,

FIG. 11 is a side cross-sectional view schematically illustrating an optical module as a comparative example.

### DETAILED DESCRIPTION

### Problem Solved by Disclosure

In recent years, along with the miniaturization of optical transceivers, it is required to reduce a height of an optical module mounted on an inside of an optical transceiver. Some of such optical modules include an optical semiconductor element (for example, semiconductor laser element), a housing including side walls having an opening to which an optical window is attached and enclosing the optical semiconductor element, and optical components (for example, an optical fiber) optically coupled to the optical semiconductor element via the optical window. In such optical modules, it is required to provide a large area for fixing the optical window to the opening on the side wall, and thus a height of a position of the optical window (that is, a height of a position of the opening) affects significantly to a dimension of the optical module in a height direction. Therefore, in order to achieve the reduction in height of the optical module, it is desirable to lower the height of the position of the optical window as much as possible.

However, since the height of the optical window is determined with reference to a height of the optical semiconductor element in order to achieve an optical coupling between the optical semiconductor element and the optical component, the following problems may occur. That is to say, the optical semiconductor element is normally mounted on various components in the housing, and it may be difficult to lower the height of the position of the optical semiconductor element to a desired position because a thickness of such a component offers a hindrance. For example, in an optical transmission module, a semiconductor laser element as an optical semiconductor element is mounted on a thermo-electric cooler (TEC) via a carrier or the like, and the TEC has a thickness to some extent. Therefore, the thickness of such a TEC specifically offers a hindrance and provides limits to lowering of the height of the position of the semiconductor laser element. Accordingly, the position of the optical window is limited to a certain level of height, and it is difficult to reduce the height of the optical module.

### Advantageous Effect of Disclosure

According to the present disclosure, the reduction of the height is achieved while ensuring an optical coupling between the optical semiconductor element and the optical component.

### Description of Embodiment of Disclosure

Contents of an embodiment of the present disclosure will now be listed up for description. An optical module according to an embodiment of the present disclosure includes an optical semiconductor element having a first optical axis, an optical an optical receptacle optically coupling with the semiconductor element and having a second optical axis thereof, a box-shaped housing having a bottom and a side wall built in an end of the bottom, and a beam shifter provided in the side wall. The housing encloses the optical semiconductor element therein but extracts the optical receptacle. The side wall of the housing demarcates the optical semiconductor element from the optical receptacle. The beam shifter aligns the first optical axis with the second optical axis.

According to the optical module described above, the beam shifter aligns the first optical axis of the optical semiconductor element and the second optical axis of the optical receptacle. Even when the height of the first optical axis of the optical semiconductor element from the bottom surface and the height of the second optical axis of the optical receptacle from the bottom surface are not aligned with each other, optical coupling of the optical semiconductor element and the optical receptacle is ensured. In addition, since the height of the optical axis of the optical receptacle from the bottom surface is lower than the height of the optical axis of the optical semiconductor element from the bottom surface, the dimension of the optical module in the height direction may be reduced. Therefore, the optical module described above provides the reduction of the height of the optical module while ensuring an optical coupling between the optical semiconductor element and the optical receptacle.

In the optical module described above, as one embodiment, the first optical axis may have a height measured from the bottom of the housing that is greater than a height of the second optical axis measured from the bottom.

In the optical module described above, as one embodiment, the side wall may provide an opening having a center that is aligned with the second optical axis. The beam shifter may cover the opening.

In the optical module described above, as one embodiment, the beam shifter may include a cover and a block. The cover can cover the opening. The block may have a thickness along a direction connecting the first optical axis with the second optical axis that is greater than a thickness of the cover along the direction. Since the beam shifter is divided into the cover and the block, a manufacturing process of the block may be separated from a manufacturing process of a housing, and therefore the housing may be manufactured at a low cost by using a general-purpose housing. In addition, flexibility of design of the block may be enhanced. The cover and the block may be integrated.

In the optical module described above, as one embodiment, the block may have refractive index greater than refractive index of the cover. According to this embodiment, incident light to the block can be refracted significantly in the block. Therefore, even when the thickness of the block is reduced, a desired offset between the height of the first optical axis of the optical semiconductor element from the bottom surface and the height of the second optical axis of the optical receptacle from the bottom surface may be achieved by the beam shifter. Consequently, since the size of the beam shifter may be reduced, miniaturization of the optical module may be achieved.

In the optical module described above, as one embodiment, the side wall may provide a bush having an opening with a center thereof that is aligned with the second optical axis, and the beam shifter may be attached to the bush. In this embodiment, the bush may provide a mounting surface inside of the housing. The mounting surface may mount the beam shifter thereon and have a normal inclined with the first optical axis and the second optical axis.

In the optical module described above, as one embodiment, the optical receptacle may include a first output port and a second output port outputting optical beams generating in the optical semiconductor element. The first and second output ports may be provided side by side in the front wall and provide respective optical axes extending parallel to the second optical axis. The beam shifter may align the first optical axis with the respective optical axes of the first and second output ports. In this embodiment, the side wall may provide a bush having an opening with a center thereof positioned in a midway between the first and second optical axes of the first and second output ports, respectively, and the beam shifter may be attached to the bush. In this embodiment, the bush may provide a mounting surface inside of the housing, and the mounting surface may mount the beam shifter thereon and have a normal inclined with the first optical axis and the second optical axis.

The method of manufacturing the optical module described above may include a first step of covering an opening provided in the side wall by the first member, arranging the cover at a position where the beam shifter compensates for the height of the first optical axis and the height of the second optical axis, and retaining the housing at the position; a second step of applying an adhesive on a surface of the cover while retaining the housing; and a third step of placing the block on the surface of the cover via the adhesive while retaining the housing. Accordingly, positional displacement of the block on the surface of the cover may be suppressed. In other words, the block may be placed on the surface of the cover with a high degree of accuracy.

The method of manufacturing the optical module described above may further include a fourth step of letting the adhesive cure with the surface kept horizontal. This suppresses positional displacement of the block on the surface of the cover further reliably. In other words, the block may be placed on the surface of the cover with a higher degree of accuracy.

### Details of Embodiment of Disclosure

Referring now to the drawings, specific examples of an optical module according to an embodiment of the disclosure will be described. The invention is not limited to the illustrations but is defined by claims, and is intended to include any modification within the meaning and scope equivalent to the claims In the following description, the same components are designated by the same reference numerals and redundant description will be omitted.

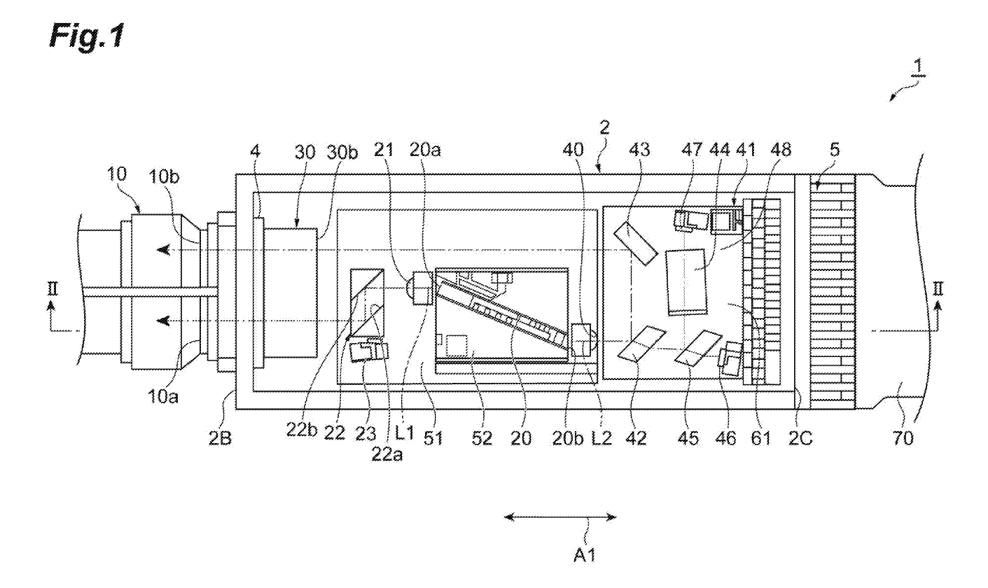

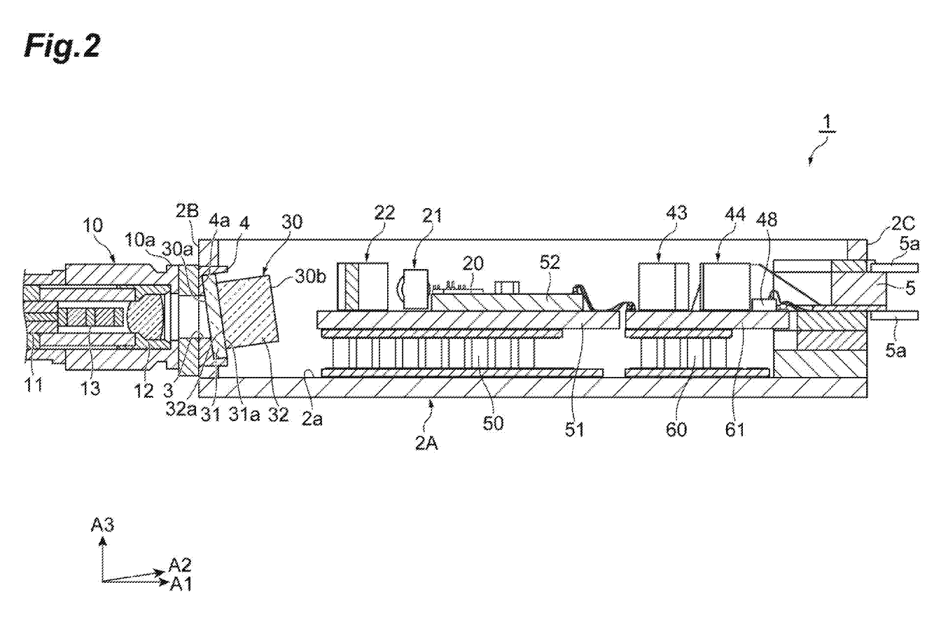

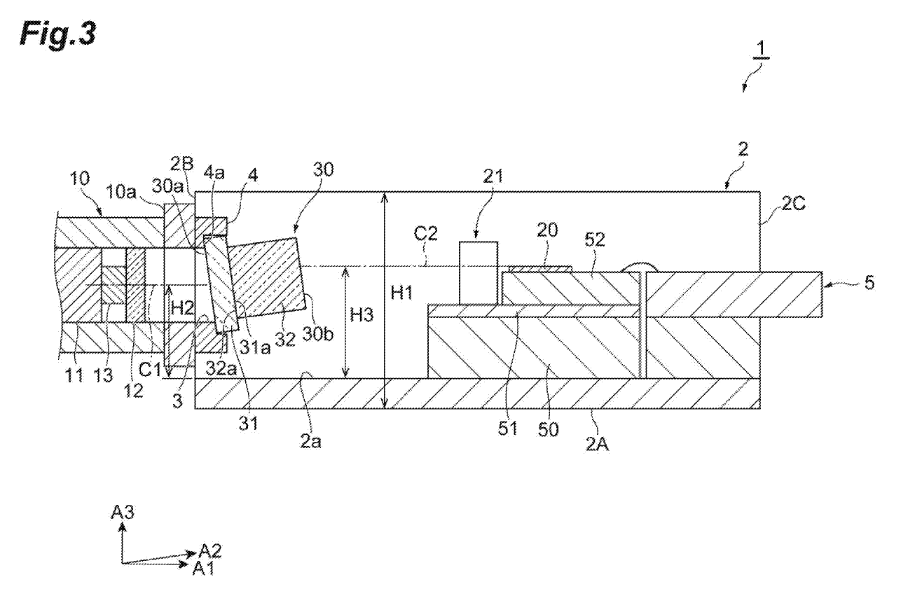

FIG. 1 is a plan view illustrating an internal structure of an optical module 1 of this embodiment. FIG. 2 is a cross-sectional view taken along a line II-II indicated in FIG. 1. FIG. 3 is a cross-sectional view schematically illustrating the optical module 1 illustrated in FIG. 2. In FIG. 3, part of the drawing is simplified for ease of understanding. In this embodiment, a semiconductor optical module including a wavelength-tunable laser diode (t-LD) 20 as an optical semiconductor element is used as the optical module 1. As illustrated in FIG. 3, the height (that is, the dimension in the depth direction A3 of the optical module 1) H1 of the optical module 1 is, for example, 3.5 mm As illustrated in FIG. 1 to FIG. 3, the optical module 1 includes a housing 2 having a substantially cuboid-shape (box-shaped) and a receptacle 10 fixed to the housing 2.

The housing 2 includes a bottom 2A, and a front wall 2B and a rear wall 2C as side walls. The bottom 2A has a bottom surface 2a exposed in the housing 2. The bottom surface 2a intersects with a depth direction A3 of the housing 2, and extends along a longitudinal direction A1 of the housing 2. The thickness of the bottom 2A is, for example, 0.5 mm The bottom surface 2a is in contact with lower ends of the front wall 2B and the rear wall 2C. The front wall 2B and the rear wall 2C intersect with the longitudinal direction A1. The front wall 2B includes an opening 3 (see FIG. 2 and FIG. 3) for attaching a receptacle 10, and a bush 4 that is annularly formed along the periphery of the opening 3. The opening 3 extends along the longitudinal direction A1 and penetrates through the front wall 2B. The bush 4 projects from the front wall 2B into the housing 2 in the longitudinal direction A1. The bush 4 includes a mounting surface 4a (see FIG. 2 and FIG. 3) that intersects with the longitudinal direction A1. A normal direction A2 of the bush 4 slightly inclines with respect to optical axes of the laser beams L1 and L2 (see FIG. 1) traveling along the longitudinal direction A1.

The rear wall 2C faces the front wall 2B in the longitudinal direction A1. The rear wall 2C is provided with a feedthrough 5 having a plurality of terminals 5a such as a lead pin. The feedthrough 5 is provided in such a way as to penetrate through the rear wall 2C and electrically connects the inside of the housing 2 and the outside of the housing 2. A flexible wiring board (FPC) 70 for performing electrical communication with the outside is conductively adhered to a plurality of terminals 5a of the feedthrough 5. An electrical signal handled by the feedthrough 5 is a substantial DC signal, such as a power supply, a bias, or a GND. The housing 2 is hermetically sealed by a lid portion, not illustrated.

The receptacle 10 is provided on the outside of the front wall 2B and communicates with an opening 3. The receptacle 10 includes a 1^{st} output port 10a and a 2^{nd} output port 10b. An optical fiber 11 (optical component), a concentrating lens 12, and an optical isolator 13 are attached to the 1^{st} output port l0a (see FIG. 2 and FIG. 3). These components are similarly attached to the 2^{nd} output port 10b. The optical fiber 11 faces the wavelength tunable LD (t-LD) 20 with the front wall 2B interposed therebetween, and is optically coupled to the t-LD 20. The optical axis C1 (see FIG. 3) of the optical fiber 11 is substantially parallel to the bottom surface 2a. The opening 3 is positioned on the optical axis C1 of the optical fiber 11. The laser beam L1 or L2 output from the t-LD 20 and passed through the opening 3 enters the optical fiber 11. The laser beam L1 or L2 incident on the optical fiber 11 is provided to the outside of the optical module 1 via the optical fiber 11.

The concentrating lens 12 is placed on an optical path between the optical fiber 11 and the t-LD 20. The height of the optical axis of the concentrating lens 12 measured from the bottom surface 2a is equal to the height of the optical axis C1 of the optical fiber 11 measured from the bottom surface 2a. In one example, the optical axis of the concentrating lens 12 is positioned on the optical axis C1 of the optical fiber 11. The concentrating lens 12 condenses the laser beam L1 or L2 output from the t-LD 20 and passed through the opening 3 to the optical fiber 11. The optical isolator 13 is provided on an optical path between the optical fiber 11 and the concentrating lens 12. The optical isolator 13 suppresses the return light from the optical fiber 11.

The optical module 1 includes an end face light emitting wavelength tunable LD (t-LD) 20. The t-LD 20 is mounted on a space defined by the bottom surface 2a, the front wall 2B, and the rear wall 2C. Specifically, the t-LD 20 is enclosed in substantially the center of the housing 2, and is placed on the bottom surface 2a. The t-LD 20 is electrically connected to the plurality of terminals 5a of the feedthrough 5. The drive signal to the t-LD 20 is supplied to the t-LD 20 through a plurality of terminals 5a from the outside of the optical module 1. As shown in FIG. 3, the optical axis C2 of the t-LD 20 is substantially parallel to the bottom surface 2a of the optical axis C2.

The height of the optical axis C2 of the t-LD 20 measured from the bottom surface 2a and the height of the optical axis C1 of the optical fiber 11 measured from the bottom surface 2a are deviated from each other. Specifically, the height of the optical axis C1 of the optical fiber 11 measured from the bottom surface 2a is smaller than the height of the optical axis C2 of the t-LD 20 measured from the bottom surface 2a. In one example, as illustrated in FIG. 3, the height H2 of the optical axis C1 of the optical fiber 11 measured from the bottom surface 2a is, for example, 1.5 mm, and the height H3 of the optical axis C2 of the t-LD 20 with respect to the bottom surface 2a is, for example, 1.75 mm.

The t-LD 20 outputs the laser beam L1 from a front facet 20a which is one of light emitting surfaces and outputs the laser beam L2 from a rear facet 20b which is the other light emitting surface (see FIG. 1). A collimating lens 21, a beam translator 22, a monitor photodiode (mPD) 23, and a beam shifter 30 are provided on the optical path of the laser beam L1. The laser beam L1 output from the front facet 20a of the t-LD 20 passes through the collimating lens 21, the beam translator 22, and the beam shifter 30 and proceeds to the 1st output port 10a.

A collimating lens 40, a wavelength locker 41, and a beam shifter 30 are provided on the optical path of the laser beam L2. The laser beam L2 output from the rear facet 20b of the t-LD 20 is converted into parallel light by the collimating lens 40, is reversed in direction of travel by the beam splitter 42 and a reflector 43, passes through a lateral side of the t-LD 20, passes through the beam shifter 30, and proceeds to the 2^{nd} output port 10b.

The optical axes of the two collimating lenses 21 and 40 are offset from each other. A longitudinal direction of the t-LD 20 is inclined at a significant angle other than 0° and 90° with respect to the respective optical axes of the collimating lenses 21 and 40. The t-LD 20 emits the laser beams L1 and L2 in parallel with the optical axis of the t-LD 20, but the t-LD 20 has a significant angle, so that the laser beams L1 and L2 are prevented from returning to the t-LD 20 by reflection.

The collimating lens 21 is placed on an optical path between the t-LD 20 and the beam shifter 30. The height of the optical axis of the collimating lens 21 measured from the bottom surface 2a is equal to the height of the optical axis C2 of the t-LD 20 measured from the bottom surface 2a. The collimating lens 21 converts the laser beam L1 emitted from the t-LD 20 from a divergent light into a parallel light.

The beam translator 22 offsets the optical axis C2 of the laser beam L1. To this end, the beam translator 22 includes reflectors 22a and 22b in a positional relationship parallel to each other. The reflector 22a has a total reflection film, and the other reflector 22b has, for example, a beam splitter film, and of which a ratio between a transmission and reflection is 5:95 (transmits by 5% and reflects by 95%). The monitor photodiodes (mPD) 23 monitors the intensity of the laser beam L1. A portion (for example, 5%) of a laser beam L1 passing through a beam splitter film of the reflector 22b is coupled to the mPD 23.

The beam shifter 30 is placed on the optical path between the t-LD 20 and the optical fiber 11 (specifically, an optical path between the concentrating lens 12 and the collimating lens 21). The beam shifter 30 is placed on the mounting surface 4a, and covers the opening 3 of the front wall 2B. The beam shifter 30 is composed of a transparent material that passes through the laser beams L1 and L2. Details of the specific configuration of the beam shifter 30 will be described later.

The optical module 1 further includes a thermo-electric cooler (TEC) 50, a base member 51, and a carrier 52. The TEC 50 is mounted on the bottom surface 2a. The TEC 50 is equipped with the t-LD 20, and controls the temperature of the t-LD 20. The thickness of the TEC 50 is, for example, 0.75 mm to 1.25 mm. The base member 51 is a plate-shaped member having a flat main surface, and is provided between the t-LD 20 and the TEC 50 in a depth direction A3, and functions as a heat sink for heat dissipation of the t-LD 20. The thickness of the base member 51 is, for example, 0.2 mm. The carrier 52 is provided between the t-LD 20 and the base member 51 in a depth direction A3. The thickness of the carrier 52 is, for example, 0.44 mm. The collimating lenses 21 and 40, the beam translator 22, the monitor photodiodes (mPD) 23, and the carrier 52 are mounted on the TEC 50 via the base member 51.

The optical module 1 further comprises a thermo-electric cooler (TEC) 60 and a base member 61. The TEC 60 is mounted on the bottom surface 2a and is placed between the TEC 50 and the rear wall 2C in the longitudinal direction A1. The TEC 60 mounts the wavelength locker 41 thereon and controls the temperature of an etalon filter 44 included in the wavelength locker 41. The base member 61 is a plate-shaped member having a flat main surface, and is provided between the wavelength locker 41 and the TEC 60 in a depth direction A3. The wavelength locker 41 includes two light splitting components (beam splitters) 42 and 45, an etalon filter 44, two monitor photodiodes (mPD) 46 and 47, a reflector 43 for beam shifting, and a thermistor 48. The beam splitters 42 and 45, the reflector 43, the etalon filter 44, the mPDs 46 and 47, and the thermistor 48 are mounted on the TEC 60 via a base member 61.

The beam splitters 42 and 45 are optically coupled to the rear facet 20b of the t-LD 20 in the housing 2. The laser beam L2 outputted from the rear facet 20b of the t-LD 20 is converted into parallel light by the collimating lens 40 and enters the beam splitter 42. The beam splitter 42 is a flat plate beam splitter, of which a ratio between transmission and reflection is 5:95 (transmits by 5%, reflects by 95%). The beam splitter 42 reflects a large part of the incident light (for example, 95%) toward the reflector 43. In contrast, the beam splitter 42 transmits a small part of the incident light (for example, 5%) toward the beam splitter 45. A reflectivity of the beam splitter 42 is set to be at least 90% (more preferably 95%) to secure the intensity of the laser light L2 output to the outside of the housing 2. The beam splitter 42 is a flat plate beam splitter provided with a dielectric multilayer film on a transparent plate. Therefore, the reflectivity of the beam splitter 42 can be easily increased compared to a prism-type beam splitter, and simultaneously, a low cost is achieved.

The beam splitter 45 splits light incident from the beam splitter 42. The beam splitter 45 is a flat plate beam splitter, of which a ratio between transmission and reflection is 50:50 (transmits by 50%, reflects by 50%). The beam splitter 45 determines a splitting ratio to the etalon filter 44. The intensity of the laser beam L2 reflected by the beam splitter 45 is sensed by a monitor photodiode (mPD) 47 after passing through the etalon filter 44. In other words, the mPD 47 senses the laser beam L2 affected by a transmission performance (transmittance) of the etalon filter 44. The intensity of the laser beam L2 passing through the beam splitter 45 is sensed by the monitor photodiode (mPD) 46 without affected by an optical component having a wavelength dependency such as the etalon filter 44. The ratio of the intensity of the laser beam L2 sensed by the mPD 46 with respect to the intensity of the laser beam L2 sensed by the mPD 46 corresponds to the transmittance of the etalon filter 44. Therefore, a relationship between the transmittance and the wavelength dependency of the laser beam L2 in the etalon filter 44 can be figured out, and thus estimation of misalignment of the wavelength of the laser beam L2 with respect to a predetermined output wavelength is enabled. Accordingly, by returning output signals from the mPDs 46 and 47 to a control signal for the t-LD 20 to reduce the misalignment of the wavelengths, the wavelengths of the laser beams L1 and L2 can be locked to any wavelengths.

A configuration of the beam shifter 30 will now be described in detail. The beam shifter 30 includes an incoming surface 30a that covers the opening 3 of the mounting surface 4a and an outgoing surface 30b placed on an opposite side from the mounting surface 4a with respect to the incoming surface 30a in the normal direction A2 as illustrated in FIG. 2 and FIG. 3. The laser beam L1 emitted from the front facet 20a of the t-LD 20 and passing through the collimating lens 21 and the beam translator 22, and the laser beam L2 emitted from the rear facet 20b of the t-LD 20 and passing through the beam splitter 42 and reflected from the reflector 43 enter the outgoing surface 30b.

The outgoing surface 30b slightly inclines with respect to a plane vertical to optical axes of the laser beams L1 and L2 incident on the outgoing surface 30b. The outgoing surface 30b inclines in such a way to face a side opposite from the bottom surface 2a in the depth direction A3. In other words, a normal vector of the outgoing surface 30b contains a component in the depth direction A3, and the component faces the side opposite from the bottom surface 2a. An angle formed between the outgoing surface 30b and a plane vertical to the optical axes of the laser beams L1 and L2 incident on the outgoing surface 30b is, for example, 20 degrees. The incoming surface 30a emits the laser beams L1 and L2 incident on the outgoing surface 30b and passing through the interior of the beam shifter 30. The laser beams L1 and L2 emitted from the incoming surface 30a pass through the concentrating lens 12 and the optical isolator 13 and then enter the optical fiber 11. The incoming surface 30a inclines along the outgoing surface 30b. In one example, the incoming surface 30a is parallel to the outgoing surface 30b.

The beam shifter 30 includes a glass plate 31 and a beam shifter 32. The glass plate 31 functions as an optical window of the housing 2. The glass plate 31 is fixed onto the mounting surface 4a in such a way to cover the opening 3. Specifically, the glass plate 31 is joined to the mounting surface 4a by, for example, brazing. Examples of the glass material of the glass plate 31 include sapphire or borosilicate glass. The glass plate 31 includes the incoming surface 30a and a front surface 31a placed on an optical path between the incoming surface 30a and the outgoing surface 30b. The front surface 31a inclines along the incoming surface 30a. In one example, the front surface 31a is parallel to the incoming surface 30a.

The beam shifter 32 is integrated with the glass plate 31. Specifically, the beam shifter 32 is joined to the glass plate 31 via an adhesive. The beam shifter 32 is placed on the optical path between the glass plate 31 and the t-LD 20 (specifically, on the optical path between the glass plate 31 and the collimating lens 21). The beam shifter 32 presents a cuboid shape extending in the normal direction A2 and may be a block. The beam shifter 32 is made of a material having a refractive index larger than the refractive index of the glass plate 31 with respect to the laser beams L1 and L2. A material of the beam shifter 32 has a good light transmission property, a linear coefficient of expansion that is close to that of Kovar (iron-nickel-cobalt alloy), and a larger refractive index is preferable as a material of the beam shifter 32. Note that Kovar is used as a material for, for example, a pipe surface and a frame of the housing 2.

The beam shifter 32 is placed on the optical path between the outgoing surface 30b and the front surface 31a and includes the outgoing surface 30b and a rear surface 32a facing the front surface 31a. The rear surface 32a inclines along the outgoing surface 30b. In one example, the rear surface 32a is parallel to the outgoing surface 30b. The incoming surface 30a, the front surface 31a, the rear surface 32a, and the outgoing surface 30b are aligned along the normal direction A2. A distance between the outgoing surface 30b and the rear surface 32a in the normal direction A2 (that is, the thickness of the beam shifter 32 in the normal direction A2) is, for example, 1.0 mm to 2.0 mm

The beam shifter 30 having such a configuration compensates for the height of the optical axis C2 of the t-LD 20 measured from the bottom surface 2a (or the height of the optical axis of the collimating lens 21 measured from the bottom surface 2a) and the height of the optical axis C1 of the optical fiber 11 measured from the bottom surface 2a (or the height of the optical axis of the concentrating lens 12 measured from the bottom surface 2a). Specifically, the beam shifter 32 of the beam shifter 30 provides an offset between the height of the optical axes of the laser beams L1 and L2 incident on the outgoing surface 30b measured from the bottom surface 2a and the height of the optical axes of the laser beams L1 and L2 emitted from the rear surface 32a measured from the bottom surface 2a with the optical axes kept horizontal. That is, the beam shifter 30 aligns the optical axis C2 with the optical axis C1.

An amount of the offset depends on a distance between the outgoing surface 30b and the rear surface 32a in the normal direction A2, an angle between the outgoing surface 30b and the rear surface 32a with respect to a plane vertical to the optical axes of the laser beams L1 and L2 incident on the outgoing surface 30b (hereinafter, this angle is referred to as “angle of beam shifter 32”), and a magnitude of the refractive index of the beam shifter 32. In other words, the amount of offset described above can be adjusted by adjusting the thickness of the beam shifter 32 in the normal direction A2, the angle of the beam shifter 32, and the refractive index of the beam shifter 32 determined by the selection of the material of the beam shifter 32.

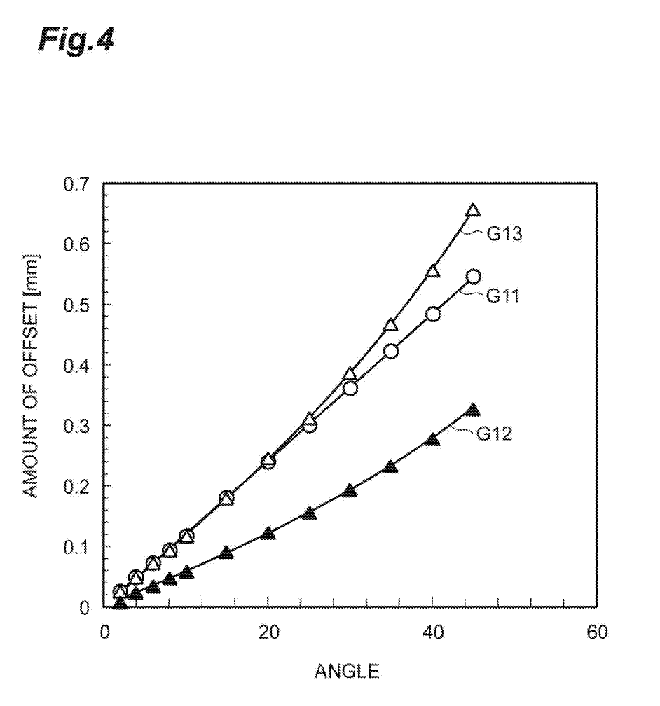

FIG. 4 shows data indicating a relationship between the angle of the beam shifter 32 and the amount of offset in a case where the material and the thickness of the beam shifter 32 are changed. In FIG. 4, the abscissa represents the angle of the beam shifter 32 and the ordinate represents the amount of offset. Graph G11 shows data in a case where the material of the beam shifter 32 is Si and the thickness of the beam shifter 32 is 1.0 mm. Graph G12 shows data in a case where BK7 is selected as the material of the beam shifter 32 and the thickness of the beam shifter 32 is set to be 1.0 mm. Graph G13 shows data in a case where BK7 is selected as the material of the beam shifter 32 and the thickness of the beam shifter 32 is set to be 2.0 mm

As illustrated in FIG. 4, the amount of offset increases with an increase of the angle of the beam shifter 32. As shown in Graphs G12 and G13, it is found that the amount of offset increases when increasing the thickness of the beam shifter 32 without changing the material of the beam shifter 32. It is also found, in contrast, that the amount of offset varies when changing the material of the beam shifter 32 without changing the thickness of the beam shifter 32. Specifically, the amount of offset when the material of the beam shifter 32 is Si having a refractive index larger than a refractive index of BK7 is larger than the amount of offset when the material of the beam shifter 32 is BK7.

By selecting the thickness, the angle, and the material of the beam shifter 32 respectively based on such a relationship, a desired amount of offset is obtained. For example, by setting the angle of the beam shifter 32 is set to 20 degrees under the condition of Graph G11 (the material of the beam shifter 32 is Si, the thickness of the beam shifter 32 is 1.0 mm) or under the condition of Graph G13 (the material of the beam shifter 32 is BK7 and the thickness of the beam shifter 32 is 2.0 mm), an amount of offset in a range from 0.2 mm to 0.3 mm is achieved. Since the thickness of the beam shifter 32 affects the size of the optical module 1 in the longitudinal direction A1, it is preferable to reduce the thickness of the beam shifter 32 as much as possible in order to miniaturize the optical module 1. In this case, it is preferable to select a material having a larger refractive index as a material of the beam shifter 32.

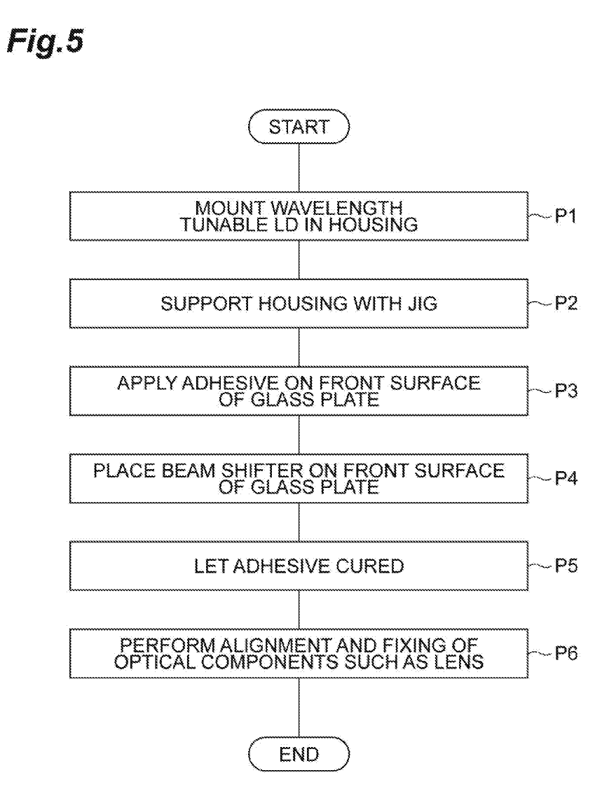

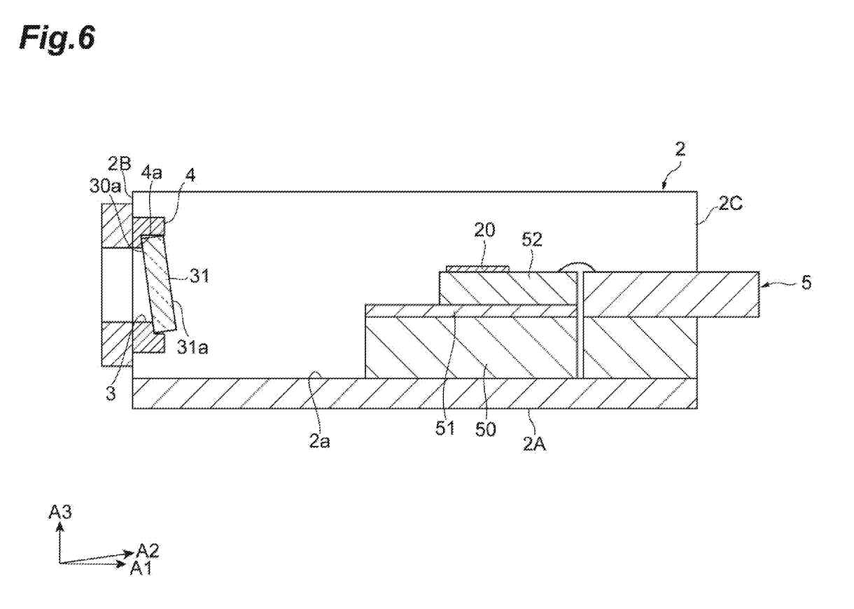

Referring now to FIG. 5 to FIG. 9, description will be given about a method of manufacturing the optical module 1 having the configuration as described thus far. FIG. 5 is a flowchart showing a method of manufacturing the optical module 1. FIG. 6 to FIG. 9 are a side cross-sectional view schematically illustrating a process of manufacturing the optical module 1.

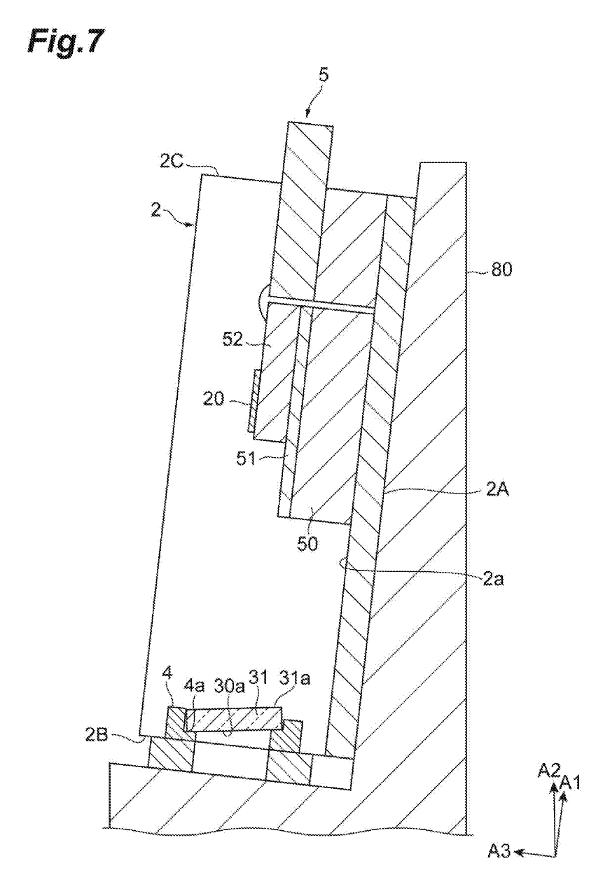

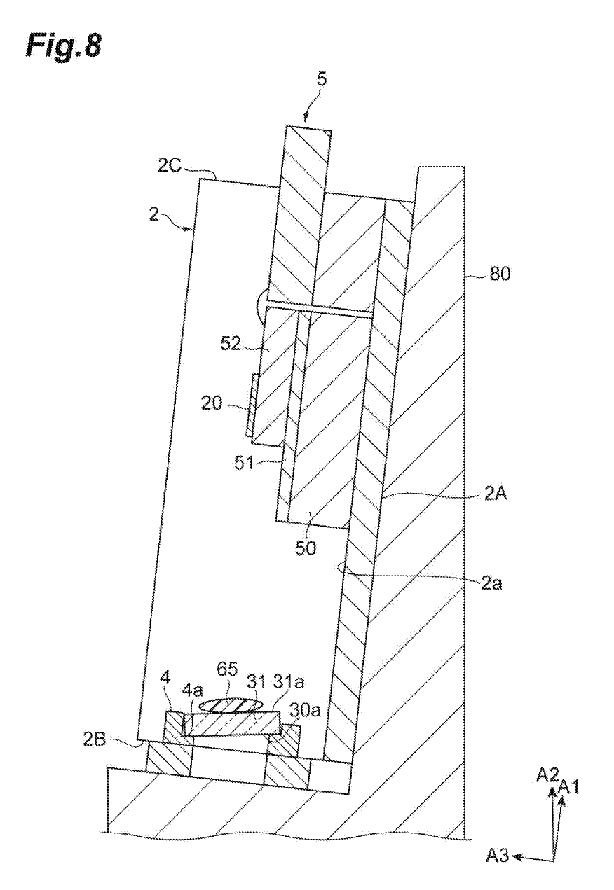

First, as shown in FIG. 6, in the housing 2, a wavelength tunable LD (t-LD) 20 is mounted on the carrier 52 by die bonding, and wire bonding is performed to electrically connect the t-LD 20 and a plurality of terminals 5a (see FIG. 2) (Process P1). Next, the opening 3 of the front wall 2B is covered with the glass plate 31, and then as illustrated in FIG. 7, a jig 80 that supports the housing 2 is prepared and the housing 2 is retained so that the optical axes of the laser beams L1 and L2 incident on the front surface 31a incline with respect to the vertical direction (Process P2). At this time, the front surface 31a of the glass plate 31 is directed upward in the vertical direction, and the housing 2 is inclined while the front surface 31a is kept horizontal. In this manner, the glass plate 31 is placed at a position to compensate for the height of the optical axis C2 of the t-LD 20 measured from the bottom surface 2a and the height of the optical axis C1 of the optical fiber 11 measured from the bottom surface 2a. Subsequently, as illustrated in FIG. 8, an adhesive 65 is applied on the front surface 31a while the front surface 31a is kept horizontal (Process P3). The adhesive 65 may be, for example, an UV curable adhesive, or, for example, may be a liquid thermosetting resin. Note that Process P2 is included in a first process in this embodiment. Process P3 is included in the second process in this embodiment.

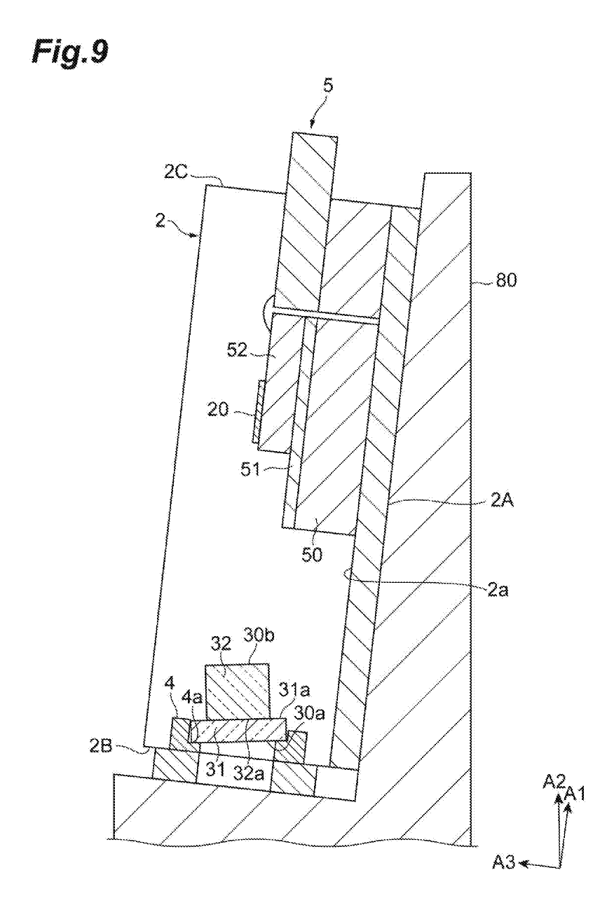

Subsequently, as illustrated in FIG. 9, the beam shifter 32 is placed on the front surface 31a via the adhesive 65 in the state in which the front surface 31a is kept horizontal (Process P4). At this time, the rear surface 32a of the beam shifter 32 faces the front surface 31a. Then, the beam shifter 32 is pressed against the glass plate 31. Subsequently, a vacuum defoaming process may be performed for removing air bubbles trapped between the rear surface 32a and the front surface 31a. Note that Process P4 is included in a third process in this embodiment.

The adhesive 65 between the rear surface 32a and the front surface 31a is cured (Process P5). Specifically, the UV is irradiated in a state where the front surface 31a is kept horizontal, or the housing 2 and the jig 80 are placed in a thermostatic chamber, and heat curing is performed. As a result, the beam shifter 32 is fixed on the front surface 31a in a state in which the horizontal levels of the outgoing surface 30b and the rear surface 32a of the beam shifter 32 are maintained. Note that Process P5 is included in a fourth process in this embodiment.

Subsequently, alignment and fixing of the optical components such as the receptacle 10 and the collimating lens 21 are performed (Process P6). Specifically, alignment and fixing are performed for each of the collimating lens 21, the concentrating lens 12, and the optical fiber 11 to couple the optical fiber 11 optically with the t-LD 20. At this time, a test light is emitted from the t-LD 20, and the alignment of the respective optical components is performed by using this test light. These optical components are fixed in the housing 2 by using the adhesive.

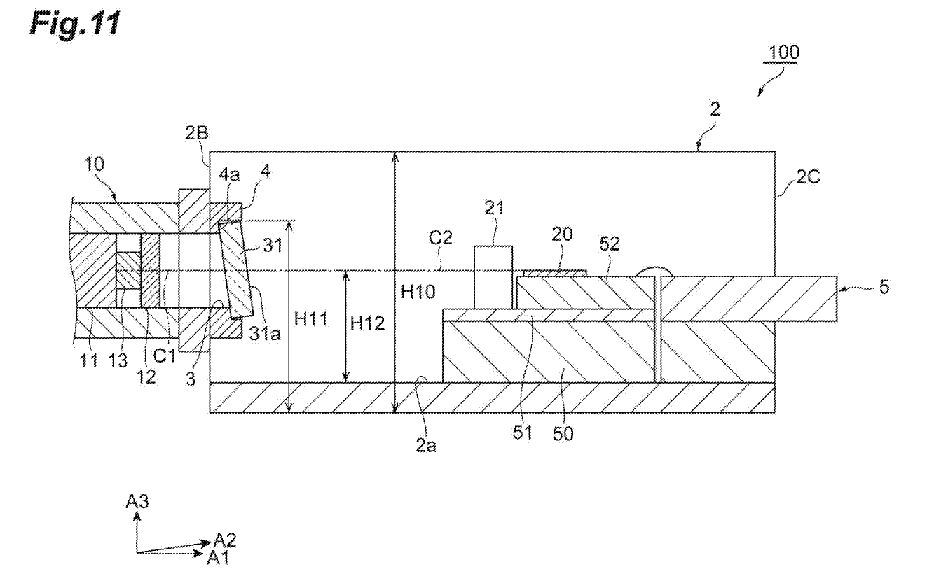

The advantageous effects obtained by the optical module 1 according to this embodiment described thus far will be described along with problems of a comparative example. FIG. 11 is a side cross-sectional view schematically illustrating an optical module 100 as a comparative example. As illustrated in FIG. 11, the optical module 100 includes a wavelength tunable LD (t-LD) 20, a housing 2 for enclosing the t-LD 20 therein, the receptacle 10 attached to the opening 3 of the front wall 2B of the housing 2, and a glass plate 31 attached to the bush 4 of the front wall 2B. The difference between the optical module 100 and the optical module 1 of this embodiment is that the optical module 100 has a glass plate 31 instead of the beam shifter 30, and that the heights of the optical axes C2 and C1 of the t-LD 20 and the optical fiber 11 measured from the bottom surface 2a coincide with each other.

A height H10 of the optical module 100 is, for example, 4.5 mm For the optical module 100 in this size, a reduction of the height is required. For example, it is required to achieve the reduction of the height of the optical module 100 so that the height of the optical module 100 is 3.6 mm When an attempt is made to set the height of the optical module 100, for example, to 3.6 mm, the area around the glass plate 31 (for example, the bush 4) offers a hindrance as shown in FIG. 11 because a height H11 of the glass plate 31 is 3.6 mm, so that it is difficult to meet the above requirements. The height of the glass plate 31 (in other words, the height of the opening 3) greatly affects the height H10 of the optical module 100 in the height direction. Therefore, in order to achieve the reduction of the height of the optical module 100, it is desirable to lower the height H11 of the glass plate 31 as much as possible.

However, since the height H11 of the glass plate 31 is determined with reference to the height of the t-LD 20 in order to achieve an optical coupling between the t-LD 20 and the optical fiber 11, the following problems may occur. That is, while the t-LD 20 is mounted on the TEC 50 via the base member 51 and the carrier 52, the thickness of the TEC 50 is, for example, 0.75 mm to 1.25 mm, and the TEC 50 has a thickness of some degree relative to the thickness of the base member 51 (for example, 0.5 mm) and the thickness of the carrier 52 (for example, 0.5 mm) Therefore, especially the thickness of the TEC 50 offers a hindrance, and limitation in the reduction of the height of the t-LD 20 may result. For example, a height H12 of the optical axis C2 of the t-LD 20 mounted on the carrier 52 measured from the bottom surface 2a is 2.1 mm When the height of the t-LD 20 is limited by the influence of the thickness of the TEC 50, the position of the glass plate 31 is limited to a certain height accordingly, and thus it becomes difficult to achieve the reduction of the height of the optical module 100.

On the other hand, in the optical module 1 of this embodiment, the outgoing surface 30b of the beam shifter 32 inclines in such a way to face upward (opposite side from the bottom surface 2a) with respect to a plane vertical to the optical axes of the laser beams L1 and L2 incident on the outgoing surface 30b. Therefore, the laser beams L1 and L2 emitted from the t-LD 20 and incident on the outgoing surface 30b are refracted downward (toward bottom surface 2a) in the beam shifter 32. Since the rear surface 32a lies along the outgoing surface 30b, the laser beams L1 and L2 emitted from the rear surface 32a are refracted upward and proceeds substantially parallel to the laser beams L1 and L2 incident on the outgoing surface 30b. In this manner, the beam shifter 32 provides an offset between the height of the optical axes of the laser beams L1 and L2 incident on the outgoing surface 30b and the height of the optical axes of the laser beams L1 and L2 emitted from the rear surface 32a. Accordingly, even when the heights of the t-LD 20 and the optical axis C1 of the optical fiber 11 measured from the bottom surface 2a are misaligned with each other, optical coupling between the t-LD 20 and the optical fiber 11 is ensured. In addition, since the height of the optical axis C1 of the optical fiber 11 measured from the bottom surface 2a is smaller than the height of the optical axis C2 of the t-LD 20 measured from the bottom surface 2a, the size of the optical module 1 in the height direction (that is, the depth direction A3) may be reduced by reducing the height of the opening 3 that allows passage of the laser beams L1 and L2 measured from the bottom surface 2a. Therefore, according to the optical module 1 of this embodiment, the reduction of the height of the optical module 1 is achieved while ensuring an optical coupling between the t-LD 20 and the optical fiber 11.

According to the optical module 1 of this embodiment, the number of mirrors for redirecting the optical path between the t-LD 20 and the optical fiber 11 in the depth direction A3 and achieving optical coupling therebetween may be reduced, and thus enlargement of the scale of the optical system between the t-LD 20 and the optical fiber 11 may be suppressed. Accordingly, this embodiment saves space in the housing 2. In addition, the number of steps that have to be done for alignment and fixing of the mirror may be reduced by the reduction of the number of such mirrors. Further, in the optical module 1 of this embodiment, since the outgoing surface 30b inclines with respect to a plane vertical to the optical axes of the laser beams L1 and L2 incident thereto, generation of return light to the t-LD 20 may be suppressed.

In contrast to the case where the beam shifter 32 is not placed on the glass plate 31 and placed on the base member 51, for example, on the optical path between the glass plate 31 and the t-LD 20, in the optical module 1 of this embodiment, the beam shifter 32 is placed on the glass plate 31, and thus a space in the housing 2 may be used efficiently, and the beam shifter 32 may be mounted efficiently in the housing 2. If the beam shifter 32 is mounted on the base member 51, mounting the beam shifter 32 in an inclined position while monitoring the angle by using a member having a cuboid shape when viewed in the longitudinal direction A1 (rectangular when viewed in a direction vertical to the longitudinal direction A1 and the depth direction A3), or mounting a member cut into a specific shape (a shape such as parallelogram when viewed in a direction vertical to the longitudinal direction A1 and the depth direction A3) is required, and issues of an increase in material cost and an increase in number of steps are likely to occur. In contrast, in the optical module 1 of this embodiment, the angle is automatically determined by pressing the beam shifter 32 against the glass plate 31, and thus the reduction of material cost or a reduction of processing cost based on a cost-effective machining method is enabled.

As in this embodiment, the beam shifter 30 includes the glass plate 31 and the beam shifter 32, the glass plate 31 and the beam shifter 32 are integrated, the glass plate 31 is attached to the front wall 2B, and the refractive index of the beam shifter 32 may be higher than the refractive index of the glass plate 31. Since the beam shifter 30 is divided into the glass plate 31 and the beam shifter 32, a step of manufacturing the beam shifter 32 may be separated from a step of manufacturing a housing 2, and the housing 2 may be manufactured at a low cost by using a general-purpose housing. In addition, flexibility of design of the beam shifter 32 may be enhanced. In addition, by making the refractive index of the beam shifter 32 with respect to the laser beams L1 and L2 higher than the refractive index of the glass plate 31 with respect to the laser beams L1 and L2, the laser beams L1 and L2 incident on the outgoing surface 30b are significantly refracted in the beam shifter 30. Therefore, even when the distance between the outgoing surface 30b and the rear surface 32a is reduced, a desired offset can be obtained between the height of the optical axis C2 of the t-LD 20 measured from the bottom surface 2a and the height of the optical axis C1 of the optical fiber 11 measured from the bottom surface 2a by the beam shifter 30. Consequently, the thickness of the beam shifter 32 may be reduced, and thus miniaturization of the optical module 1 is achieved. In addition, when the beam shifter 32 includes a semiconductor, by setting a band gap wavelength of the semiconductor to be longer than the wavelength of the laser beams L1 and L2, the transmittance of the beam shifter 32 with respect to the laser beams L1 and L2 incident on the outgoing surface 30b may be increased. That is, a light absorption constant of the beam shifter 32 with respect to the laser beams L1 and L2 may be lowered. When the semiconductor is made of Si, it is advantageous in terms of price and availability.

In this embodiment, the beam shifter 30 may provide an offset between the height of the optical axis of the collimating lens 21 measured from the bottom surface 2a and the height of the optical axis C1 of the optical fiber 11 measured from the bottom surface 2a instead of the t-LD 20. In this mode as well, the same effect as those described above may be achieved.

As in this embodiment, the beam shifter 30 may provide an offset between the height of the optical axis of the concentrating lens 12 measured from the bottom surface 2a and the height of the optical axis C2 of the t-LD 20 measured from the bottom surface 2a instead of the optical fiber 11. In this mode as well, the same effect as those described above may be achieved.

As in this embodiment, the method of manufacturing the optical module 1 may include: Process P2 of covering the opening 3 with the glass plate 31, placing the glass plate 31 at a position where the beam shifter 30 compensates for the height of the optical axis C2 and the height of the optical axis C1, and retaining the housing 2 at the position; Process P3 of applying the adhesive 65 to the front surface 31a of the glass plate 31 while retaining the housing 2; and Process P4 of placing the beam shifter 32 on the front surface 31a via the adhesive 65 while retaining the housing 2. Accordingly, positional displacement of the beam shifter 32 on the front surface 31a may be suppressed. In other words, the beam shifter 32 may be placed on the front surface 31a with high degree of accuracy. In addition, the beam shifter 32 may be maintained at a predetermined position without inserting a specific jig into the interior of the housing 2, which makes manufacture easy.

As in this embodiment, the method of manufacturing the optical module 1 may include, after Process P4, Process P5 of curing the adhesive 65 with the front surface 31a kept horizontal. Accordingly, positional displacement of the beam shifter 32 on the front surface 31a may be suppressed further reliably. In other words, the beam shifter 32 may be placed on the front surface 31a with high degree of accuracy.

As in this embodiment, by performing Process P1 before Processes P2 to P6, lowering of mounting accuracy of the beam shifter 32 may be reduced. The reason for this is that, since the die bond mounting and the wire bonding mounting which require high-temperature treatment are carried out in Process P1, if Process P1 is performed after Process P2 to Process P6, the mounting position of the beam shifter 32 may be displaced due to the influence of the high-temperature treatment. Specifically, if the die bond mounting of the t-LD 20 is performed after the beam shifter 32 is fixed by using the adhesive 65, heat treatment at a high temperature exceeding, for example, 300° C. is performed in the die bond mounting for melting solder. Therefore, the temperature of the adhesive 65 may exceed a glass-transition point of the adhesive 65 due to the influence of this heat treatment. Consequently, the position of mounting the beam shifter 32 may vary. Accordingly, such mounting displacement due to the influence as described above may be suppressed by performing Processes P2 to P6 after Process P1.

### (First Modification)

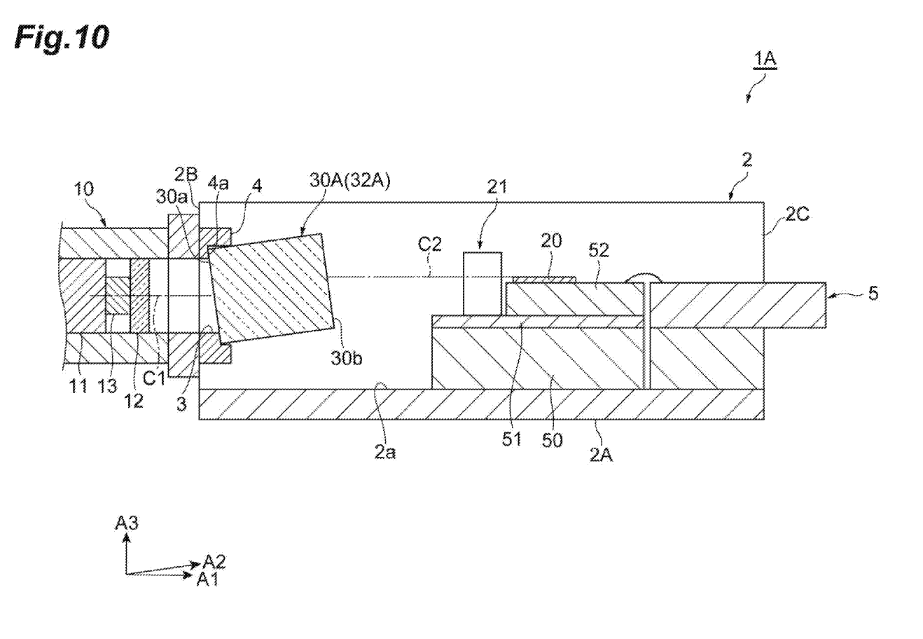

FIG. 10 is a side cross-sectional view schematically illustrating the optical module 1A according to a first modification of the embodiment described above. The different point between the present modification and the above-described embodiment is that the beam shifter 30A of the optical module 1A of this modification has a beam shifter 32A instead of the glass plate 31 and the beam shifter 32. The beam shifter 32A is different from the beam shifter 32 of the embodiment described above in including the incoming surface 30a instead of the rear surface 32a. The beam shifter 32A is made of a transparent material such as sapphire or borosilicate glass. In the optical module 1A of this modification, the outgoing surface 30b of the beam shifter 32A inclines in such a way to face opposite side from the bottom surface 2a with respect to the plane vertical to the optical axes of the laser beams L1 and L2 incident on the outgoing surface 30b. Therefore, the laser beams L1 and L2 emitted from the t-LD 20 and incident on the outgoing surface 30b are refracted toward the bottom surface 2a in the beam shifter 32. Since the incoming surface 30a lies along the outgoing surface 30b, the laser beams L1 and L2 emitted from the incoming surface 30a are refracted to the opposite side from the bottom surface 2a and proceeds substantially parallel to the laser beams L1 and L2 incident on the outgoing surface 30b. In this manner, the beam shifter 32A provides an offset between the height of the optical axes of the laser beams L1 and L2 incident on the outgoing surface 30b and the height of the optical axes of the laser beams L 1 and L2 emitted from the incoming surface 30a, and thus the optical module 1A achieves the same effects as the effects of the embodiment described above. In addition, according to the modification, since the process for fixing the beam shifter 32 to the glass plate 31 (specifically, Process P2 to P5 in the above-described embodiment) may be omitted, assembly and design of the optical module 1A can be performed easily.

### (Second Modification)

In the embodiment described above, an example of the semiconductor optical module having the t-LD 20 has been described as the optical module 1. In this modification, a semiconductor optical module including a light-receiving element (optical semiconductor element) instead of the t-LD 20 will be described for example of the optical module 1. In this case, the optical fiber 11 emits signal light, and the signal light enters the light-receiving element. Specifically, the signal light emitted from the optical fiber 11 and incident on the rear surface 32a is refracted in the beam shifter 32 on the side opposite from the bottom surface 2a and enters the outgoing surface 30b. The signal light emitted from the outgoing surface 30b is refracted toward the bottom surface 2a, proceeds in substantially parallel to the signal light incident on the rear surface 32a, and enters the light-receiving element. In this manner, the beam shifter 32 provides an offset between the height of the optical axis of the signal light incident on the rear surface 32a and the height of the optical axis of the signal light emitted from the outgoing surface 30b. Accordingly, even when the heights of the light-receiving element and the optical axis of the optical fiber 11 measured from the bottom surface 2a are misaligned with each other, optical coupling between the light-receiving element and the optical fiber 11 is ensured. Accordingly, according to this modification, the same effect as that of the above embodiment can be achieved. Note that in the manufacturing process P6 of the optical module 1 of this modification, the test light source is installed outside of the housing 2, and the test light is injected into the housing 2 from the test light source. Accordingly, alignment and fixing are performed for respective optical components such as the collimating lens 21, the concentrating lens 12, and the optical fiber 11, and the optical fiber 11 and the light-receiving element are optically coupled.

The optical module and the method of manufacturing the optical module of the present invention are not limited to the embodiments described above and other various modifications are possible. For example, the above-described embodiment and respective modifications may be combined with each other in accordance with the desired purpose and effect. Further, in the above embodiment and the respective modifications, the optical isolator 13 is enclosed in the receptacle 10. However, an optical isolator of a self-retaining type which can be adhered directly to the incoming surface 30a of the glass plate 31 is also applicable, and the isolator may be mounted on the base member 51. Further, in the above embodiment and the respective modifications, a semiconductor optical module having a t-LD 20 or a light-receiving element has been described as an example, but the present invention can also be applied to a semiconductor optical module having other optical semiconductor elements. For example, the present invention may be applied to the semiconductor optical module having a modulator (a multivalued modulator chip) as the optical semiconductor element.

What is claimed is:

1. An optical module, comprising:
an optical semiconductor element having a first optical axis thereof;
an optical receptacle optically coupling with the semiconductor element and having a second optical axis thereof; and
a box-shaped housing having a bottom and a side wall built in an end of the bottom, the housing enclosing the optical semiconductor element therein but extracting the optical receptacle, the side wall of the housing demarcating the optical semiconductor element from the optical receptacle; and
a beam shifter provided in the side wall, the beam shifter aligning the first optical axis with the second optical axis.

2. The optical module according to claim 1,
wherein the first optical axis has a height measured from the bottom of the housing that is greater than a height of the second optical axis measured from the bottom.

3. The optical module according to claim 1,
wherein the side wall provides an opening having a center that is aligned with the second optical axis, the beam shifter covering the opening.

4. The optical module according to claim 3,
wherein the beam shifter includes a cover and a block, the cover covering the opening, the block having a thickness along a direction connecting the first optical axis with the second optical axis that is greater than a thickness of the cover along the direction.

5. The optical module according to claim 4,
wherein the block has refractive index greater than refractive index of the cover.

6. The optical module according to claim 1,
wherein the side wall provides a bush having an opening with a center thereof that is aligned with the second optical axis, and
wherein the beam shifter is attached to the bush.

7. The optical module according to claim 6,
wherein the bush provides a mounting surface inside of the housing , the mounting surface mounting the beam shifter thereon, the mounting surface having a normal inclined with the first optical axis and the second optical axis.

8. The optical module according to claim 1,
wherein the optical receptacle includes a first output port and a second output port outputting optical beams generating in the optical semiconductor element, the first and second output ports being provided side by side in the front wall and providing respective optical axes extending parallel to the second optical axis, and
wherein the beam shifter aligns the first optical axis with the respective optical axes of the first and second output ports.

9. The optical module according to claim 8,
wherein the side wall provides a bush having an opening with a center thereof positioned in a midway between the first and second optical axes of the first and second output ports, respectively, and
wherein the beam shifter is attached to the bush.

10. The optical module according to claim 8,
wherein the bush provides a mounting surface inside of the housing, the mounting surface mounting the beam shifter thereon, the mounting surface having a normal inclined with the first optical axis and the second optical axis.
